(19) United States
(12) Patent Application Publication
(10) Pub. No.: US 2009/0069019 A1
(43) Pub. Date: Mar. 12, 2009

(54) MOBILE COMMUNICATION SYSTEM, SERVER APPARATUS, BASE STATION AND MOBILE TERMINAL

(75) Inventors: Akira Hayama, Kanagawa-ken (JP); Keiji Yamamoto, Tokyo (JP); Kazuya Negishi, Tokyo (JP); Shogo Ayame, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/188,494

(22) Filed: Aug. 8, 2008

(30) Foreign Application Priority Data
Sep. 12, 2007 (JP) 2007-236860

(51) Int. Cl. H04W 40/00; H04M 1/00; H04B 1/38

(52) U.S. Cl. 455/445; 455/561; 455/550.1; 455/450

(57) ABSTRACT

A mobile communication system that is possible to find a base station connectable with a mobile terminal efficiently is provided. A server apparatus, the base station and the mobile terminal used in the mobile communication system are also provided. The mobile communication system includes a mobile terminal, a plurality of base stations, a management section and an answering BS instruction section. The management section manages each connectable number of the mobile terminals with which each base station being able to establish a communication connection and selects the base station to send a connection answer to the mobile terminal based on the connectable numbers. The answering BS instruction section instructs the management section to start to select the base station to send the connection answer, and instructs the base station selected by the management section to send the connection answer to the mobile terminal.

### CROSS REFERENCE TO RELATED APPLICATION

This application is based upon and claims the benefit of priority from Japanese Patent Application No. 2007-236860, filed on Sep. 12, 2007, the entire contents of which are incorporated herein by reference.

### FIELD OF THE INVENTION

This invention relates to a mobile communication system which realizes mobile communications using a line switching network, IP(Internet Protocol) network, etc., and relates to a server apparatus, a base station and a mobile terminal which are used in the mobile communication system.

### DESCRIPTION OF THE BACKGROUND

Generally, a mobile communication system has a plurality of base stations constituting a call area, a mobile terminal for requesting a communication connection in the call area and a network connected to each of the base stations. Many call areas equivalent to the above-mentioned call area are connected to the network, and communication between mutual call areas is enabled.

In a conventional mobile communication system, when a mobile terminal starts communication with another mobile terminal, a sending mobile terminal sends a connection request to a base station with the highest receiving signal level among a plurality of base stations. If the base station is connectable to the connection request, the base station sends a connection answer to the sending mobile terminal and realizes a communication connection with the another mobile terminal in other call area connected through a network.

If radio resource which can be used by the base station are short and it is impossible to make a connection to the connection request from the mobile terminal, the base station notifies a connection refusal to the mobile terminal. The radio resource here mean remaining radio resource which can be used for connecting a communication with the mobile terminal. Since the radio resource are consumed when the mobile terminal communicates with the base station, a number which one base station can connect with mobile terminals is restricted by remaining radio resource. If the mobile terminal is notified of a connection refusal, the mobile terminal sends a connection request to another base station and looks for a connectable base station. Sending of connection request is repeated until a connectable base station is found.

If the connectable base station is found immediately, sending of the connection request is good only once. However if there are two or more base stations which are not connectable, the mobile terminal has to try to send the connection requests to three or more base stations until the mobile terminal finds the connectable base station, and long time is required.

Japanese Laid-Open Patent application No. 2006-211129 discloses a mobile communication system. In the mobile communication system, each base station knows its radio resource respectively. If a usage rate of the radio resource of the base station which received a connection request from a mobile terminal is higher than a predetermined threshold level, the base station communicates with a control station and the control station assigns a base station which connects to the mobile terminal. Moreover, when the usage rate of the radio resource is lower the predetermined threshold level, the base station assigns itself as the base station which connects to the mobile terminal without communicating with the control station.

As mentioned above, a mobile communications system which can find a connectable base station efficiently and can shorten the time to a communication connection between a mobile terminal and a base station has been desired.

### SUMMARY OF THE INVENTION

Accordingly, an object of the present invention is to provide a mobile communication system which is possible to find a connectable base station efficiently and to shorten the time to a communication connection.

In accordance with the invention, a mobile communication system includes a mobile terminal, a plurality of base stations, a management section, and an answering BS instruction section. The mobile terminal is configured to send a connection request. Each base station is configured to send a connection answer to the connection request to the mobile terminal sent the connection request and to establish a communication connection with the mobile terminal sent the connection request. The management section is configured to manage each connectable number indicating a number of the mobile terminals with which each base station being possible to establish the communication connection, and to perform a procedure to select the base station to send a connection answer to the mobile terminal sent the connection request based on the connectable numbers managed. The answering BS instruction section is configured to instruct the management section to start the procedure to select the base station to send the connection answer, and to instruct the base station selected by the management section to send the connection answer when the mobile terminal send the connection request.

### BRIEF DESCRIPTION OF THE DRAWINGS

FIG. 1 is a block diagram illustrating a structure of a mobile communication system according to a first embodiment.

FIG. 2 is a block diagram illustrating a functional structure of a base station according to the first embodiment.

FIG. 3 is a sequence diagram illustrating a procedure which a base station notifies the remaining radio resource information to a BS selection server according to the first embodiment.

FIG. 4 is a block diagram illustrating a structure of the BS selection server according to the first embodiment.

FIG. 5 is an exemplary diagram illustrating a radio resource management table according to the first embodiment.

FIG. 6 is a sequence diagram illustrating a procedure of a communication connection in the mobile communication system according to the first embodiment.

FIG. 7 is a block diagram illustrating a functional structure of a base station according to a second embodiment.

FIG. 8 is a block diagram illustrating a structure of a BS selection server according to the second embodiment.

FIG. 9 is a sequence diagram illustrating a procedure of a communication connection in a mobile communication system according to the second embodiment.

FIG. 10 is a block diagram illustrating a BS selection server according to a third embodiment.

FIG. 11 is a block diagram illustrating a functional structure of a base station according to a fourth embodiment.

FIG. 12 is a block diagram illustrating a structure of a BS selection server according to the fourth embodiment.

FIG. 13 is a sequence diagram illustrating a procedure in a mobile communication system according to the fourth embodiment.

FIG. 14 is a block diagram illustrating a BS selection server according to a fifth embodiment.

FIG. 15 is a sequence diagram illustrating a procedure of a communication connection in a mobile communication system according to a sixth embodiment.

FIG. 16 is a sequence diagram illustrating a procedure of a communication connection in a mobile communication system according to a seventh embodiment.

FIG. 17 is a block diagram illustrating an exemplary structure when a function of a BS selection server is provide in a base station of a mobile communication system according to an eight embodiment.

### DETAILED DESCRIPTION OF THE INVENTION

Now, the embodiments will be explained in detail with reference to the drawings.

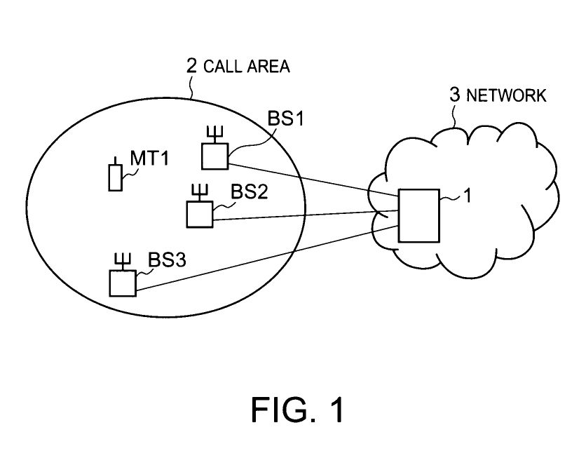

FIG. 1 is a schematic block diagram illustrating a functional structure of a mobile communication system according to the first embodiment. Each base station BS1-BS3 has a radio zone in which the base station can receives radio signal respectively and the radio zones form call area 2. Mobile terminal MT1 exists in call area 2 and communicates any one of base stations BS1-BS3. Base stations BS1-BS3 are connected to network 3. Network 3 is connected to other call area (not shown) and enables the communication connection with the mobile terminal existing in other call area.

BS(Base Station) selection server 1 exists in network 3, and is connected to base stations BS1-BS3. In BS selection server 1, a management section manages a connectable number which shows a number of the mobile terminals with which each base station BS1-BS3 can establish the communication connections. That is, a radio resource management section manages a remaining radio resource which each base station BS1-BS3 needs for the communication in this embodiment. Here the radio resource means, for example, a bandwidth in a radio section.

Mobile terminal MT1 sends a connection request to a base station with the highest receiving signal level to mobile terminal MT1 among base stations BS1-BS3 at the time of call. Hereinafter a case that base station BS1 receives the connection request will be explained.

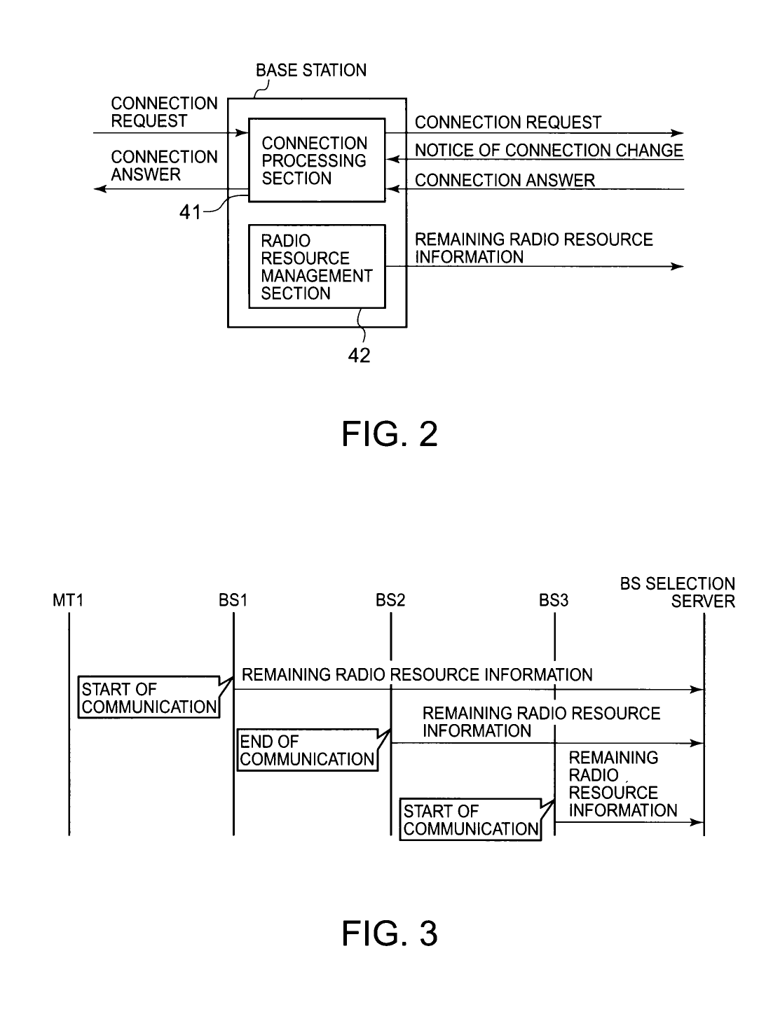

FIG. 2 is a schematic block diagram illustrating a functional structure of base station BS1 according to the first embodiment. Base station BS1 includes connection processing section 41 and radio resource management section 42.

In base station BS1, connection processing section 41 receives a connection request from mobile terminal MT1 and sends the connection request to BS selection server 1.

When connection processing section 41 receives a connection answer instructing a start of the communication between mobile terminal MT1 and base station BS1 from BS selection server 1, connection processing section 41 sends the connection request to mobile terminal MT1 and base station BS1 starts the communication with mobile terminal MT1. When connection processing section 41 receives a notice of connection change which informs the communication with a base station other than base station BS1 from BS selection server 1, connection processing section 41 destroys the connection request which received from mobile terminal MT1.

Base station BS1 manages the radio resource which remains in itself by radio resource management section 42. Base station BS1 establishes the communication with the mobile terminal within allowable amount of the radio resource. That is, the communication connection between each base station BS1-BS3 and the mobile terminal is established within a limit of the radio resource which remains in each base station BS1-BS3. That is, the base station with which the radio resource does not remain can not establish new communication with the mobile terminal.

Furthermore, in each base station BS1-BS3, radio resource management section 42 notifies BS selection server 1 of the remaining radio resource information at the start of the communication with the mobile terminal, and at the end of the communication. At this time, the remaining radio resource information includes as a information the radio resource which each of base stations BS1-S3 can use at that time. When radio resource management section 42 receives an instruction of sending the remaining radio resource information from connection processing section 41, radio resource management section 42 sends the remaining radio resource information to BS selection server 1.

FIG. 3 is a sequence diagram illustrating a procedure at the time when base stations BS1-BS3 inform the remaining radio resource information to BS selection server 1 according to the first embodiment. Since base stations BS1 and BS3 started the communication with the mobile terminals, base stations BS1 and BS3 informed their remaining radio resources to BS selection server 1. And since base station BS2 finished the communication with the mobile terminals, base stations BS1 informed its remaining radio resource to BS selection server 1.

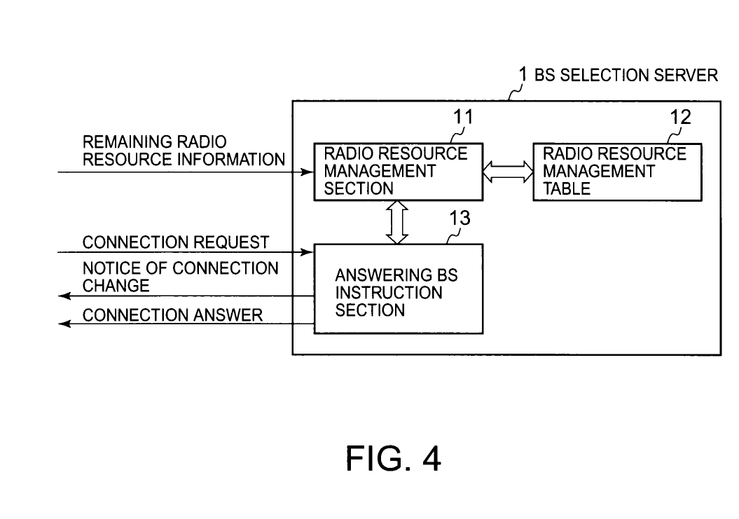

FIG. 4 is a block diagram illustrating a BS selection server 1 according to the first embodiment. BS selection server 1 includes radio resource management section 11 as the management section mentioned above, radio resource management table 12 and answering BS instruction section 13.

Radio resource management section 11 receives the remaining radio resource information from each base station BS1-BS3, and manages the remaining radio resource of each base station BS1-BS3 by radio resource management table 12. And when radio resource management section 11 receives a search instruction signal which instructs a start of selection of the base station from answering BS instruction section 13, radio resource management section 11 selects the base station with the most remaining radio resource base on the remaining radio resource managed in radio resource management table 12, and notifies answering BS instruction section 13 of the base station selected.

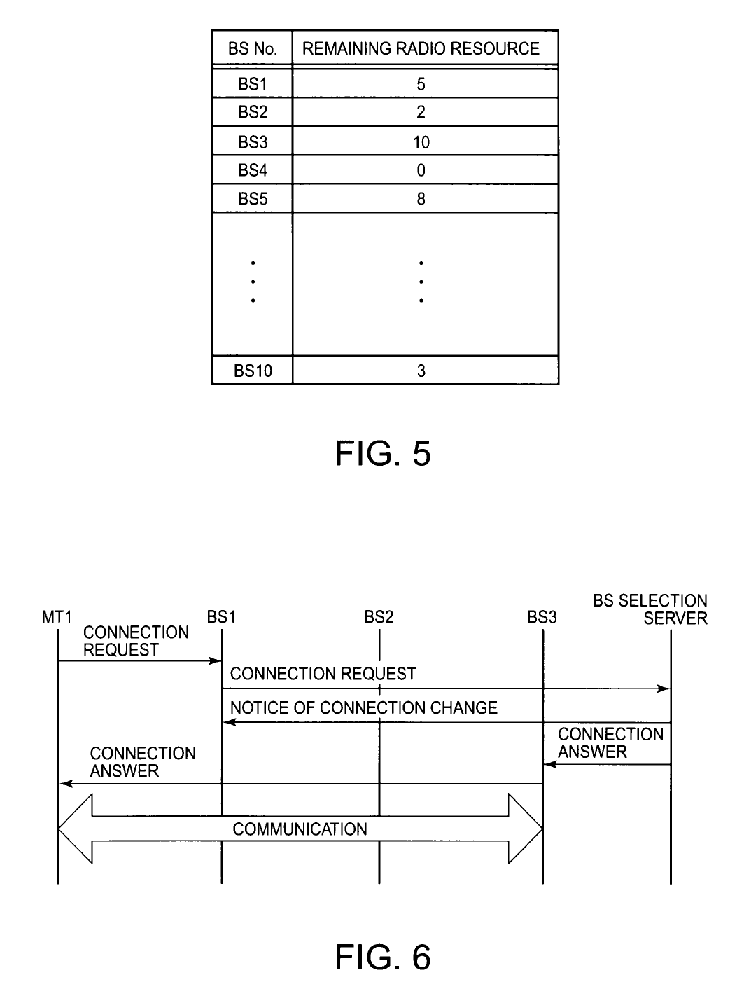

FIG. 5 is a drawing illustrating one example of radio resource management table 12. Radio resource management table 12 is a table which records the remaining radio resource with respect to each base station BS1-BS3 in call area 2. Radio resource management table 12 also records base stations BS4-BS10 not shown in FIG. 1. And in radio resource management table 12, each of base stations BS1-BS10 and respective remaining radio resource are arranged so that radio resource management section 11 can search the optimum base station which the mobile terminal communicates with.

Answering BS instruction section 13 receives a connection request from base station BS1, and sends a search instruction signal to radio resource management section 11. When answering BS instruction section 13 receives a notice of the selected base station from radio resource management section 11, answering BS instruction section 13 judges whether the selected base station corresponds with base station BS1 which requested the connection request. If the selected base station differs from base station BS1, answering BS instruction section 13 sends a notice of connection change to base station BS1, and then sends a connection answer to the selected base station. If the selected base station corresponds with base station BS1 which requested the connection request, answering BS instruction section 13 sends the connection answer to base station BS1.

Next in the above-mentioned structure, the operation of the mobile communication system will be explained.

FIG. 6 is a sequence diagram illustrating a procedure of the communication connection of the mobile communication system according to the first embodiment. This sequence diagram explains a case that after base station BS1 receives the connection request from mobile terminal MT1 base station BS3 receives the connection answer from BS selection server 1 and commences to communicate with mobile terminal MT1.

First, mobile terminal MT1 sends the connection request to base station BS1. Base station BS1 which received the connection request forwards the connection request to BS selection server 1. When BS selection server 1 receives the connection request, BS selection server 1 selects base station BS3 which is the most suitable base station to connect with reference to the remaining radio resource recorded in radio resource management table 12, and sends the connection answer to base station BS3 after sending a notice of the connection change to base station BS1. Base station BS3 which received the connection answer sends the connection answer to mobile terminal MT1 and commences to communicate with mobile terminal MT1.

As explained above, according to the first embodiment, BS selection server 1 manages each of the remaining radio resources of base stations BS1-BS3 in real time by receiving each of the remaining radio resources from each of base stations BS-BS3. When BS selection server 1 receives a connection request from base station BS1, BS selection server 1 selects base station BS3 which is the most suitable base station to make a communication connection with mobile terminal MT1 among base stations BS1-BS3 based on the remaining radio resources managed.

That is, the remaining radio resources of base stations BS1-BS3 are managed in real time by BS selection server 1. If this is used, a process for searching a base station which can make a communication connection with the mobile terminal becomes the minimum. That is, if radio resource management table 12 of BS selection server 1 is referred to when the connection request from the mobile terminal occurs, the base station suitable for connecting with the mobile terminal requesting the connection request can be found out immediately.

Therefore it becomes unnecessary to repeat sending of the connection request until a connectable base station is found, and it becomes possible to shorten the time from the call to the connect.

Furthermore, since the amount of the information sent and received among the mobile terminal, the base stations and the sever system at the time of start of communication is made to the minimum, a traffic concerning a transfer of the information is made to the minimum and the load of the system is also made to the minimum.

As mentioned above, since the mobile communication system can find the connectable base station efficiently, it becomes possible to shorten the time to commence the communication connection between mobile terminal MT1 and base station BS1-BS3.

That is, in the mobile communication system according to the embodiment, when the mobile terminal sends the connection request, the base station which should return the connection answer to the connection request is determined based on the remaining radio resources managed at the radio resource management section. For this reason, even if it is in the state that two or more base stations are not connectable, the mobile terminal can connect with the suitable base station without asking those base stations one by one.

A mobile communication system according to the second embodiment will be explained. The mobile communication system has a common channel band which is used for broadcasting a connection request to all base stations BS1-BS3 at a time. Mobile terminal MT1 broadcasts the connection request to all base stations BS1-BS3 using the common channel band.

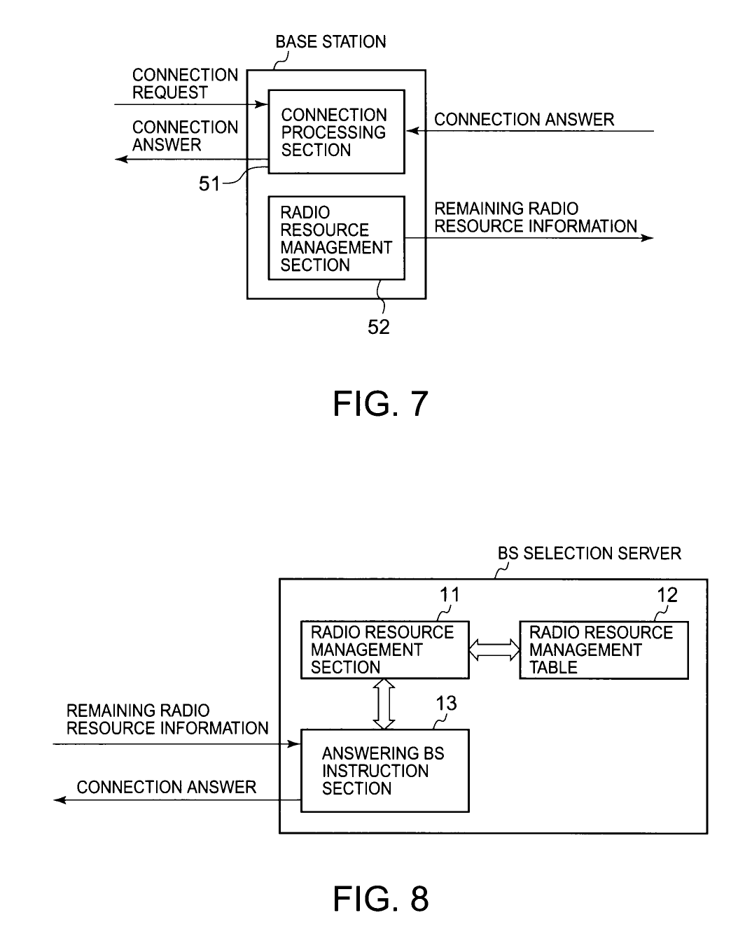

FIG. 7 is a block diagram illustrating a functional structure of base station BS1-BS3 according to the second embodiment. Each of base stations BS1-BS3 includes connection processing section 51 and radio resource management section 52.

When connection processing section 51 receives the connection request from mobile terminal MT1, connection processing section 51 instructs radio resource management section 52 to the send remaining radio resource information to BS selection server 1. Furthermore, when connection processing section 51 receives a connection answer from BS selection server 1, connection processing section 51 sends a connection answer to mobile terminal MT1. Thereby, a communication connection between the base station and mobile terminal MT1 is established.

Radio resource management section 52 manages the remaining radio resource of self base station. When radio resource management section 52 receives an instruction of sending the remaining radio resource information from connection processing section 51, radio resource management section 52 sends the remaining radio resource information to BS selection server 1

FIG. 8 is a block diagram of a functional structure of BS selection server 1 according to the second embodiment. BS selection server 1 includes radio resource management section 11, radio resource management table 12 and answering BS instruction section 13.

Answering BS instruction section 13 receives the remaining radio resource information from base stations BS1-BS3 and sends the remaining radio resource information to radio resource management section 11. When answering BS instruction section 13 received all the remaining radio resources form all base stations BS1-BS3 and answering BS instruction section 13 sends a search instruction signal which instructs a search of the base station with the most remaining radio resources to radio resource management section 11. And when answering BS instruction section 13 is notified of a selected base station from radio resource management section 11, answering BS instructing section 13 sends the connection answer to the selected base station.

When radio resource management section 11 receives the remaining radio resource information from answering BS instruction section 13, radio resource management section 11 stores the remaining radio resource information in radio resource management table 12 for every base station BS1-BS3. When the remaining radio resource information of all base stations BS1-BS3 in call area 2 is stored in radio resource management table 12, radio resource management section 11 selects the base station with the most remaining radio resource base on the remaining radio resource managed in the radio resource management table 12 by the search instruction signal from BS instruction section 13, and notifies answering BS instruction section 13 of the selected base station. When the connection answer is sent to the selected base station from answering BS instruction section 13, radio resource management section 11 deletes the remaining radio resource information stored in radio resource management table 12.

Next, in the above-mentioned structure, an operation of the mobile communication system will be explained.

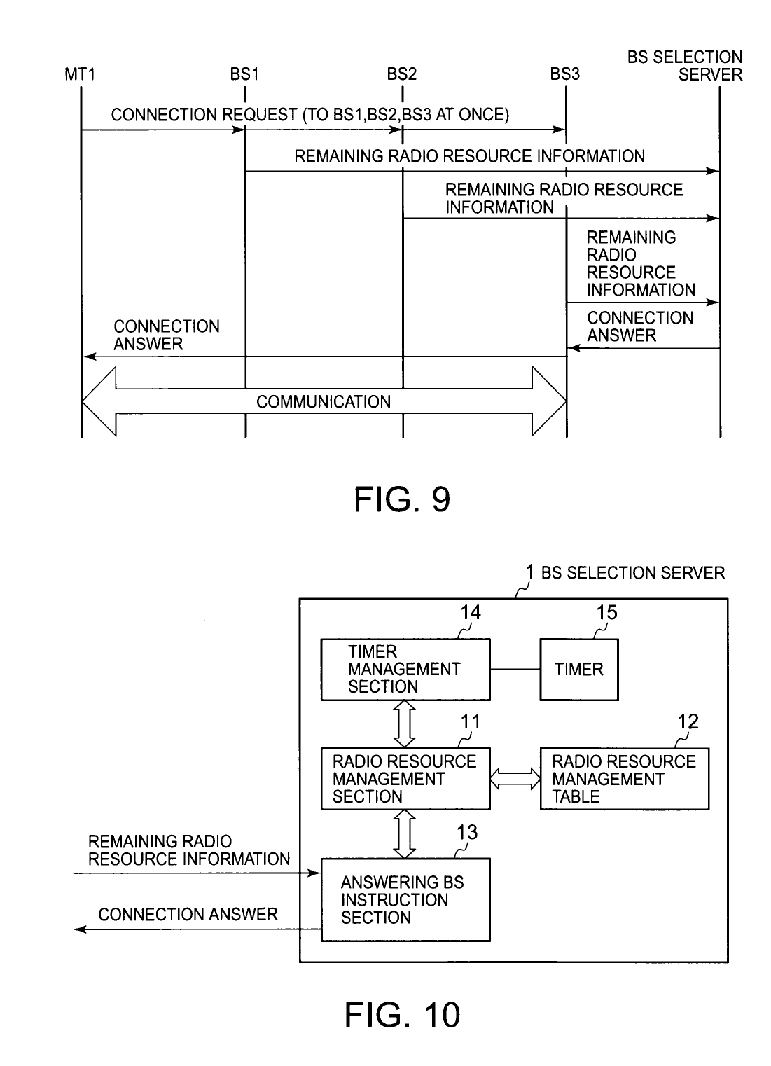

FIG. 9 is a sequence diagram illustrating a procedure of a communication connection of the mobile communication system according to the second embodiment. This sequence diagram explains a case that base station BS3 receives a connection answer from BS selection server 1 and commences to communicate with mobile terminal MT1 after base stations BS1-BS3 received a connection request from mobile terminal MT1.

Mobile terminal MT1 broadcasts the connection request to all base stations BS1-BS3 using the common channel band first. When each base station BS1-BS3 received the connection request, each base station BS1-BS3 sends the remaining radio resource information to BS selection server 1 in order. When BS selection server 1 receives the remaining radio resource information, BS selection server 1 stores the remaining radio resource information in radio resource management table 12, and selects a suitable base station to connect with reference to this information. BS selection serve 1 sends the connection answer to selected base station BS3. Base station BS3 which received the connection answer sends the connection answer to mobile terminal MT1 and starts communication with mobile terminal MT1.

As mentioned above, according to the second embodiment, when each of base stations BS1-BS3 receives the connection request broadcasted by mobile terminal MT1, each of base stations BS1-BS3 sends the remaining radio resource information to BS selection server 1. BS selection server 1 stores the remaining radio resource of each base station BS1-BS3, and selects the base station which is most suitable for making a communication connection with mobile terminal MT1 with reference to this remaining radio resource. Thereby, since BS selection server 1 can know the remaining radio resource of each base station BS1-BS3 whenever mobile terminal MT1 sends the connection request, BS selection server 1 becomes possible to select efficiently the most suitable base station for the communication connection to the connection request from mobile terminal MT1.

Accordingly, the base station connectable to the mobile terminal can be found efficiently, and the time to the communication connection can be shortened.

FIG. 10 is a functional block diagram illustrating a BS selection server 1 according to a third embodiment. Timer 15 and timer management section 14 are added to BS selection server 1 according to a second embodiment shown in FIG. 8. Timer 15 counts a predetermined fixed time. When answering BS instruction section 13 receives first remaining radio resource information, timer management section 14 makes timer 15 start a count. And when fixed time counted with a timer 15 expires, timer management section 14 instructs radio resource management section 11 to start selecting a base station with the most remaining radio resource.

Radio resource management section 11 stores in radio resource management table 12 the remaining radio resource information received from answering BS instruction section 13 during the fixed time period. And when radio resource management section 11 receives the instruction for starting of selection of the base station from timer management section 14, radio resource management section 11 starts selection of the base station with the most remaining radio resource base on the remaining radio resources stored in radio resource management table 12 even if radio resource management section 11 has not received all the remaining radio resource information from all base stations BS1-BS3. That is, even if radio resource management section 11 does not receive the search instruction signal from answering BS instruction section 13, radio resource management section 11 starts selection of the base station with the most remaining radio resource, when radio resource management section 11 receives the instruction of the selection start from timer management section 14. Radio resource management section 11 selects the base station and notifies answering BS instruction section 13 of the selected base station. When answering BS instruction section 13 sends a connection answer to the selected base station, radio resource management section 11 delete the remaining radio resource information stored in radio resource managed table 12.

Thereby, without receiving the remaining radio resource information from all the base stations in call area 2, BS selection server 1 becomes possible to select the base station. Accordingly even if it is required a longer time than the predetermined time period to receive the remaining radio resource information from all the base stations because of confusion of a communication line, for example, it becomes unnecessary to wait until the remaining radio resource information of all the base stations is received, and the time to start the communication connection can be shortened.

Mobile communication system according to the fourth embodiment will be explained. The mobile communication system according to the fourth embodiment has a common channel band for broadcasting a connection request to all base stations BS1-BS3 as well as the second embodiment. Mobile terminal MT1 broadcasts a connection request to all base stations BS1-BS3 by using the common channel band.

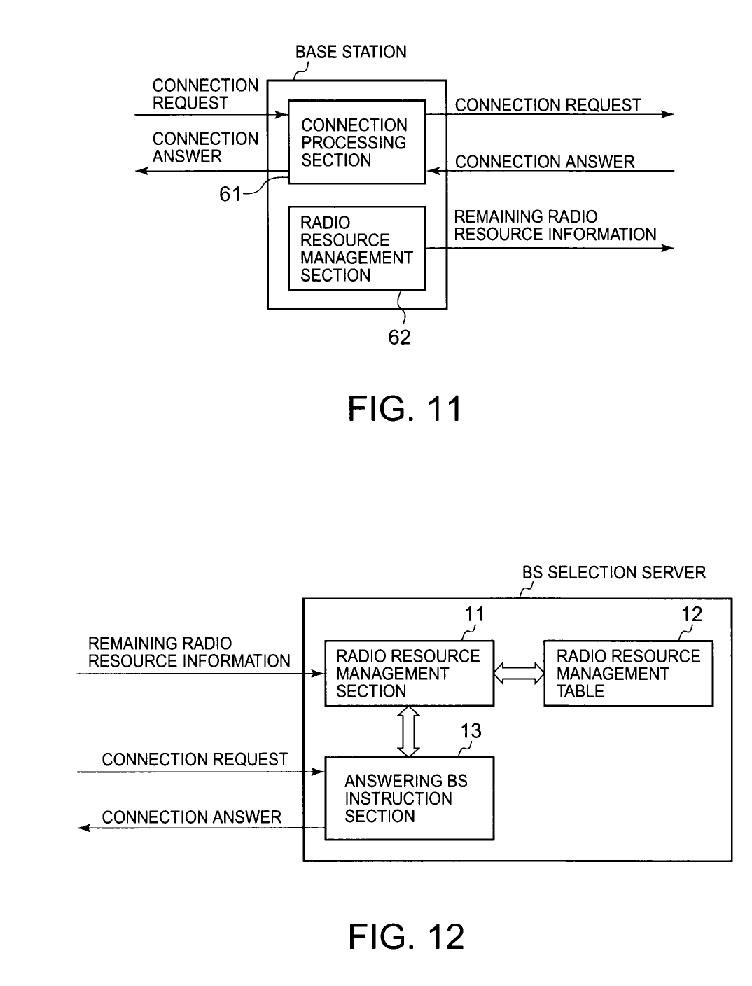

FIG. 11 is a block diagram illustrating a functional structure of base station BS1-BS3 according to the fourth embodiment. Each base station BS1-BS3 has connection processing section 61 and radio resource management section 62.

Connection processing section 61 receives the connection request from mobile terminal MT1. When connection processing section 61 receives the connection request, connection processing section 61 forwards the connection request to BS selection server 1. And when connection processing section 61 receives a connection answer from BS selection server 1, connection process section 61 sends the connection answer to mobile terminal MT1, and thereby a communication connection between the base station and mobile terminal MT1 is established.

Radio resource management section 62 manages a radio resource which remains in the self-apparatus. Radio resource management section 62 sends remaining radio resource information to BS selection server 1 when base station BS1-BS3 starts communication with the mobile terminal and when base station BS1-BS3 ends communication with the mobile terminal, as well as the first embodiment shown in FIG. 3. FIG. 12 is a block diagram illustrating a structure of main part of BS selection server 1 according to the fourth embodiment. BS selection server 1 has radio resource management section 11, radio resource management table 12 and answering BS instruction section 13.

Radio resource management section 11 receives the remaining radio resource information from each base station BS1-BS3 and manages the remaining radio resource of each base station BS1-BS3 with radio resource management table 12. And when radio resource management section 11 receives a search instruction signal from answering BS instruction section 13, radio resource management section 11 selects the base station with the most remaining radio resource base on the remaining radio resource managed in radio resource management table 12, and notifies answering BS instruction 13 of the selected base station.

When answering BS instruction section 13 receives the connection requests from all base stations BS1-BS3, answering BS instruction section 13 sends a search instruction signal to radio resource management section 11. And when answering BS instruction selection 13 receives a notice of the selected base station from radio resource management section 11, answering BS instruction selection 13 sends a connection answer to the selected base station.

Next in above mentioned structure, an operation of the mobile communication system will be explained.

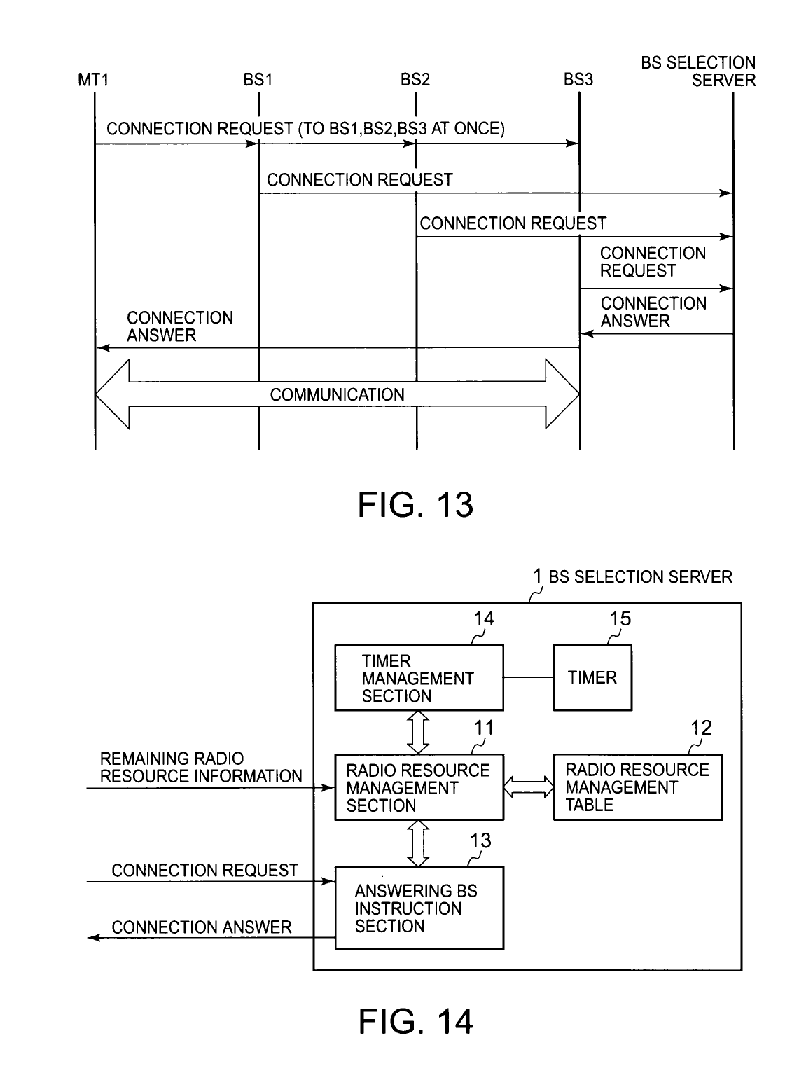

FIG. 13 is a sequence diagram illustrating a procedure of the communication connection of the mobile communication system according to the fourth embodiment. This sequence diagram explains a case that base station BS3 receives a connection answer from BS selection server 1 and starts communication with mobile terminal MT1 after base stations BS1-BS3 receive the connection request from mobile terminal MT1.

Mobile terminal MT1 broadcasts the connection request to all base stations BS1-BS3 using a common channel band first. Each base station BS1-BS3 which receives the connection request forwards the connection request to BS selection server 1. When BS selection server 1 receives the connection requests from all base stations BS1-BS3, BS selection server 1 selects the base station with the most remaining radio resource based on the remaining radio resources stored in radio resource management table 12 and instructs for sending of the connection answer to selected base station BS3. Base station BS3 which is instructed to send the connection answer notifies mobile terminal MT1 of the connection answer and starts communication with mobile terminal MT1.

As mentioned above, according to the fourth embodiment, BS selection server 1 manages the remaining radio resources of base stations BS1-BS3 in real time by receiving the remaining radio resources from each of base stations BS1-BS3. When BS selection server 1 receives connection requests forwarded from all base stations BS1-BS3, BS selection server 1 selects the most suitable base station to connect with mobile terminal MT1 with reference to the remaining radio resources of base stations BS1-BS3 Thereby BS selection server 1 refers the remaining radio resources of base stations BS1-BS3 and becomes possible to efficiently select the base station connectable to the connection request of mobile terminal MT1.

Therefore, according to the mobile communication system of this embodiment, the base station connectable with the mobile terminal can be discovered efficiently, and the time to the communication connection can be shortened.

FIG. 14 is a functional block diagram illustrating BS selection server 1 according to the fifth embodiment. Timer 15 and timer management section 14 are added to BS selection server 1 according to the fourth embodiment. Timer 15 counts a predetermined fixed time. When answering BS instruction section 13 receives first connection request, timer management section 15 makes timer 15 start a count. When the fixed time counted with timer 15 expires, timer management section 15 instructs radio resource management section 11 to start selection of a base station with the most remaining radio resource based on the remaining radio resources managed in the radio resource management table 12.

When radio resource management section 11 receives the instruction of a start of selection of the base station from timer management section 14, radio resource management section 11 starts to select the base station with the most remaining radio resource based on the remaining radio resources stored in radio resource management table 12 even if radio resource management section 11 did not receive the search instruction signal from answering BS instruction section 13.

Thereby it becomes possible to select the base station without receiving the connection requests from all base stations existing in call area 2. Therefore it becomes unnecessary to wait until the connection requests from all base station are received, and becomes possible to shorten the time to the communication connection.

A mobile communication system according to the sixth embodiment will be explained. According to the sixth embodiment, BS selection server 1 has a function like the second embodiment. Mobile terminal MT1 sends connection requests to all base stations BS1-BS3 one by one at a predetermined interval in order when mobile terminal MT1 connects communication with the base station,

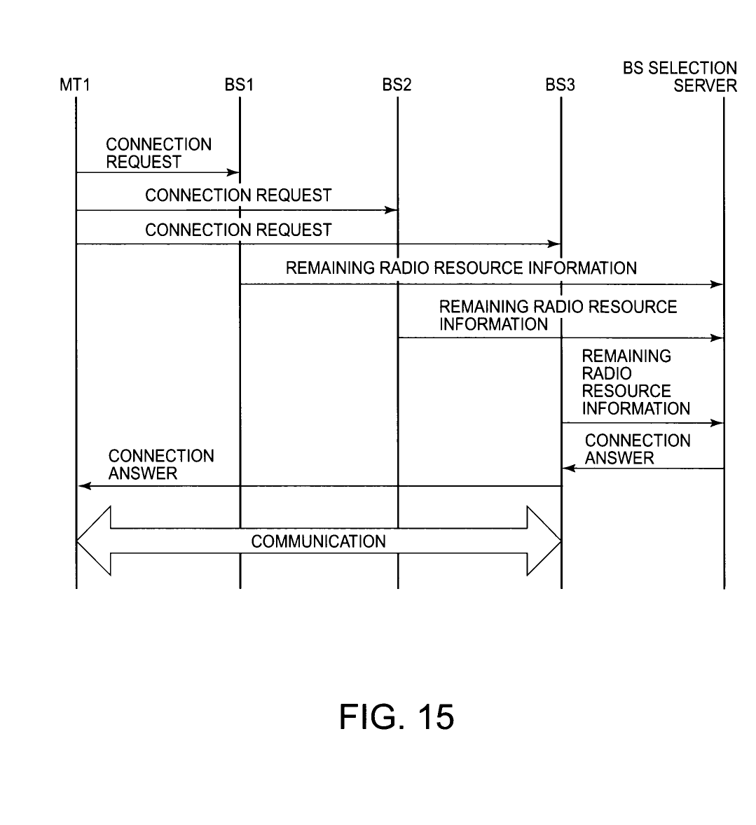

FIG. 15 is a sequence diagram illustrating a procedure of a communication connection of the mobile communication system according to the sixth embodiment. This sequence diagram explains a case that base station BS3 receives a connection answer from BS selection server 1 and starts communication with mobile terminal MT1 after base station BS1-BS3 received the connection requests from mobile terminal MT1.

Mobile terminal MT1 sends connection requests to all base stations BS1-BS3 at a predetermined time interval first. When base stations BS1-BS3 receive the connection requests, base stations BS1-BS3 send remaining radio resource information to BS selection server 1. When BS selection server 1 receives the remaining radio resource information, BS selection server 1 stores all the remaining radio resource information sent in radio resource management table 12 and selects the connectable base station BS3 with reference to the remaining radio resource information. BS selection server 1 sends the connection answer to base station BS3. Base station BS3 which received the connection answer sends a connection answer to mobile terminal MT1 and starts communication with mobile terminal MT1.

As mentioned above, according to the sixth embodiment, when base stations BS1-BS3 receive the connection requests sent by mobile terminal MT1 at a predetermined interval time, base stations BS1-BS3 send the remaining radio resources to BS selection server 1 in order. Corresponding to this, BS selection server 1 stores the remaining radio resource information of each base station BS1-BS3 in radio resource management table 12 and selects the most suitable base station to make the communication connection with mobile terminal MT1 with reference to the remaining radio resources. Thereby the mobile communication system becomes possible to find the connectable base station efficiently without using a common channel band.

Therefore, according to the mobile communication system of the sixth embodiment, the base station connectable with the mobile terminal can be found efficiently, and the time to the communication connection can be shortened.

BS selection server 1 according the sixth embodiment becomes possible to select the base station based on the remaining radio resources stored by providing timer 15 and timer management section 14 like BS selection server 1 of the third embodiment shown in FIG. 10 even, if BS selection server 1 does not receive the remaining radio resource information from all the base station existing in call area 2.

A mobile communication system according to the seventh embodiment will be explained. In the seventh embodiment, base stations BS1-BS3 and BS selection server 1 have functions similar to the fourth embodiment. Mobil terminal MT1 sends connection requests to all base stations BS1-BS3 at predetermined interval time in order when mobile terminal MT1 connects communication with the base station.

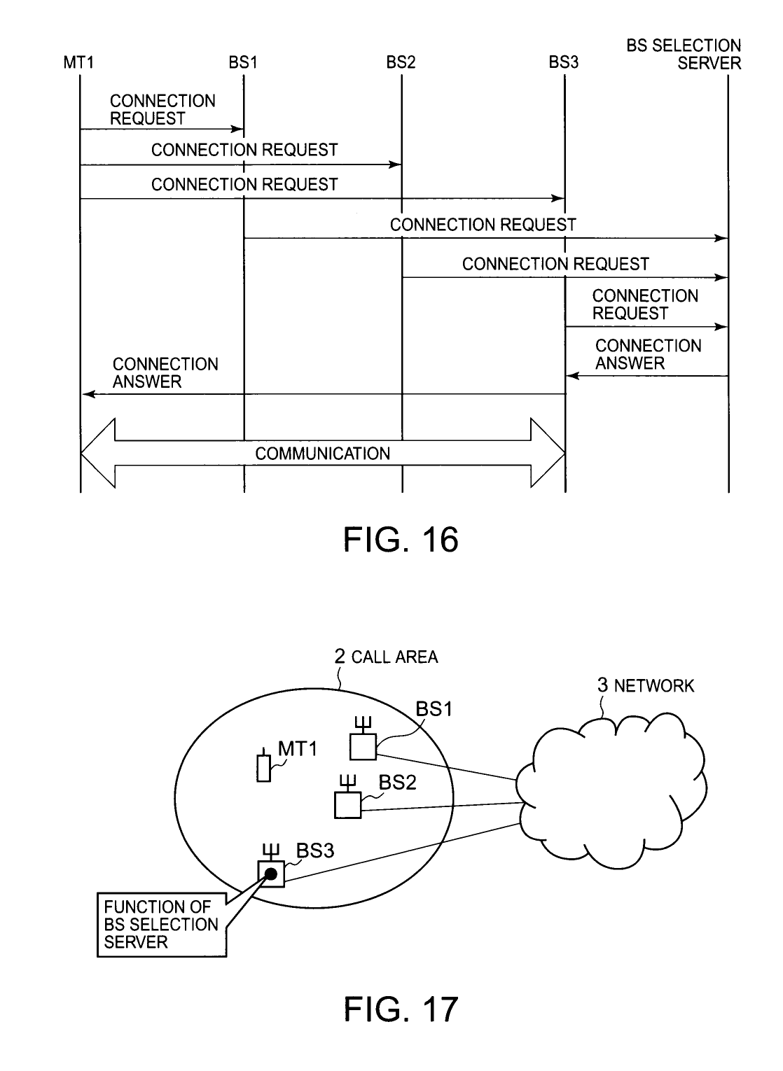

FIG. 16 is a sequence diagram illustrating a procedure of the communication connection of the mobile communication system according to the seventh embodiment. This sequence diagram explains a case that base station BS3 receives a connection answer from BS selection server and starts the communication with mobile terminal MT1 after base station BS1-BS3 receives the connection request from mobile terminal MT1.

Mobile terminal MT1 sends the connection requests to all base stations BS1-BS3 at predetermined interval time in order first. Base stations BS1-BS3 which received the connection requests forward the connection requests to BS selection server 1. When BS selection server 1 receives the connection requests from all base stations BS1-BS3, BS selection server 1 selects the base station with the most remaining radio resource based on the remaining radio resources stored in the radio resource management table 12. And BS selection server 12 instructs sending of the connection answer to selected base station BS3. Base station BS3 which is instructed the sending of the connection answer notifies mobile terminal MT1 of the connection answer and starts the communication with mobile terminal MT1.

According to the seventh embodiment, BS selection server 1 manages the remaining radio resources of base stations BS1-BS3 at real time by receiving remaining radio resource from each base station BS1-BS3. And when BS selection server 1 receives the connection requests sent by all base station BS1-BS3 at predetermined interval time in order, BS selection server 1 selects the most suitable base station to make the communication connection with mobile terminal MT1 with reference to the remaining radio resources of base stations BS1-BS3. Thereby the mobile communication system becomes possible to find the connectable base station efficiently without using the common channel band.

According to the mobile communication system of the seventh embodiment, the connectable base station with the mobile terminal is found efficiently and the time to the communication connection can be shortened.

In BS selection server 1 according to this embodiment, if timer 15 and timer management section 15 are provided as shown in FIG. 14, the mobile communication system becomes possible to select the base station based on the remaining radio resource without receiving the connection requests from all base stations existing in call area 2.

The invention is not limited to above mentioned embodiments. Although, in the embodiments mentioned above, for example, the embodiments that the base station is selected by managing the radio resources of the base stations are explained, the mobile communication system can be realized even if a call resource of the base station is managed. Here the call resource means a number of radio channels which the base station has, and which is required for the base station to communicate with the mobile terminal.

Although the embodiments that BS selection server 1 selects the base station with the most remaining radio resource are explained, a case that BS selection server selects the base station at random among some base stations with a large remaining radio resource, or selects the base station at random among the base stations with the large remaining radio resource above the predetermined level, can be realized like the embodiments explained above.

Furthermore in a case that the BS selection server grasps the call resource of the base station, the invention can be realized in case that the BS selection server selects the base station with the most remaining radio channel number, selects the base station at random among some base stations with the large remaining radio channel number, or selects the base station at random among the base stations with the remaining radio channel number above the predetermined.

Furthermore in the embodiments that the timer is provided, the timer management section gives the search instruction signal to the radio resource management section. However, the timer management section can notify the answering BS instruction section of the elapse of the predetermined time period and the answering BS instruction section can give the search instruction signal to the radio resource management section.

Furthermore in the embodiments that the BS selection server grasps the radio resources on real time, it is possible to select the base station with the most radio resource always by the radio resource management section. Thereby it becomes possible to notify the answering BS instruction section of the base station to response fast and it becomes possible to shorten the time to the communication connection with the mobile terminal. That is, when the base station receives the connection request from the mobile terminal the base station notifies the BS selection server of the connection request, the BS selection server sends the connection request to the base station which was selected beforehand.

Although above embodiments explain the cases that the BS selection server 1 exists in network 3, the function of BS selection server 1 can be provided in one or more of base station BS1-BS3. In this case a physical position of the BS selection server is changed, however a connection sequence is not changed explained in above mentioned embodiments. Thus the function of BS selection server is not necessary to exist in the network and a change of the position can be analogically considered easily.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A mobile communication system, comprising:
a mobile terminal configured to send a connection request;
a plurality of base stations, each base station being configured to send a connection answer to the connection request to the mobile terminal sent the connection request and to establish a communication connection with the mobile terminal sent the connection request;
a management section configured to manage each connectable number indicating the number of the mobile terminals with which each base station being able to establish the communication connection, and to perform a procedure to select the base station to send the connection answer to the mobile terminal that sent the connection request based on the connectable number managed; and
an answering BS instruction section configured to instruct the management section to start the procedure to select the base station to send the connection answer, and to instruct the base station selected by the management section to send the connection answer when the mobile terminal sends the connection request.

2. The mobile communication system according to claim 1, wherein the mobile terminal sends the connection request to one of the base stations, and the base station sends the connection request to the answering BS instruction section when the base station receives the connection request from the mobile terminal.

3. The mobile communication system according to claim 2, wherein
the answering BS instruction section sends a notice of connection change to the base station which sends the connection request if the case the base station which is determined to send the connection answer differs from the base station which sent the connection request, and sends a connection answer to the base station which is determined to send the connection answer; and
the base station deletes the connection request received from the mobile terminal when the base station receives the notice of connection change, and sends the connection answer to the mobile terminal when the base station receives the instruction of sending the connection answer.

4. The mobile communication system according to claim 1, wherein
the mobile terminal broadcasts the connection request to a plurality of base stations,
the base station sends the connectable number to the answering BS instruction section when the base station receives the connection request from the mobile terminal, and
the management section manages the connectable number notified to the answering BS instruction section for each base station.

5. The mobile communication system according to claim 1, wherein
the mobile terminal broadcasts the connection request to a plurality of base stations, and
the base station sends the connection request received from the mobile terminal to the answering BS instruction section when the base station receives the connection request from the mobile terminal.

6. The mobile communication system according to claim 1, wherein
the mobile terminal sends the connection requests to a plurality of the base station in order,
the base station sends the connectable number to the answering BS instruction section when the base station receives the connection request, and
the management section manages the connectable number notified to the answering BS instruction section for each base station.

7. The mobile communication system according to claim 1, wherein
the mobile terminal sends the connection requests to a plurality of base station in order, and
the base station sends the connection request to the answering BS selection section when the base station receives the connection request from the mobile terminal.

8. The mobile communication system according to claim 4 or 6, further comprising
a timer configured to count a predetermined fixed time, and
a timer management section configured to start a count when the answering BS instruction section being notified of first connectable number, and instructs the management section to start the procedure to select the base station to send the connection answer among the base stations notified of the connectable numbers when the predetermined fixed time is expired.

9. The mobile communication system according to claims 5 or 7, further comprising
a timer counting a predetermined fixed time, and
a timer management section configured to start a counts when the answering BS instruction section being transferred first connection request, and to instruct the management section to start the procedure to select the base station to send the connection answer among the base stations which transfer the connection request when the predetermined fixed time being expired.

10. The mobile communication system according to claim 1, wherein the management section evaluates the connectable number for a radio resource.

11. The mobile communication system according to claim 1, wherein the management section evaluates the connectable number for a call resource.

12. The mobile communication system according to claim 1, wherein the management section and the answering BS instruction section are connected to a network which is connectable to a plurality of the base station.

13. The mobile communication system according to claim 1, wherein the management section and the answering BS instruction section are installed in at least one of a plurality of the base station.

14. The mobile communication system according to any one of claims 2, 3, 5 and 7, wherein the base station informs the connectable number to the management section when a start of the communication with the mobile terminal and when an end of the communication with the mobile terminal, and management section manages the connectable number for each base station.

15. The mobile communication system according to claims 4 or 6, wherein the answering BS instruction section instructs the management section to start the procedure to select the base station and instructs the base station selected by the management section to send the connection answer when the answering BS selection section receives the radio resource information sent from all the base stations managed by the management section.

16. The mobile communication system according to claim 5 or 7, wherein the answering BS instruction section instructs the management section to start the procedure to select the base station and instructs the base station selected by the management section to send the connection answer when the answering BS selection section receives the connection requests sent from all the base stations managed by the management section.

17. A server apparatus used for a mobile communication system establishing a communication connection between a mobile terminal sent a connection request and a base station sent a connection answer to the connection request, the server apparatus comprising:
management section configured to manage each connectable number indicating a number of the mobile terminals with which each base station being possible to make a communication connection, and to select the base station to return the connection answer to the mobile terminal sent the connection request based on the connectable number managed, and
an answering BS instruction section configured to instruct the management section to start the procedure to select the base station and to instruct the base station which is selected by the management section to send the connection answer when the base station sent the connection request.

18. The server apparatus according to claim 17, wherein when the mobile terminal sends the connection request to one of a plurality of the base stations and the base station received the connection request sends the connection request to the answering BS instruction section, the answering BS instruction section instructs the selected base station to send the connection answer after the answering BS instruction section sends a notice of connection change to the base station sent the connection request when base station which is selected to send the connection request differs from the base station sent the connection request.

19. The server apparatus according to claim 17, wherein the answering BS instruction section receives the connection request from the base station received the connection request from the mobile terminal.

20. The server apparatus according to claim 17, wherein the answering BS instruction section receives the connectable number from the base station received the connection request from the mobile terminal.

21. The server apparatus according to any one of claim 17, 18 and 19, wherein the answering BS selection section receives a radio resource from the base station when a start of the communication between the base station and the mobile terminal and when an end of the he communication between the base station and the mobile terminal.

22. The server apparatus according to claim 19, further comprising:
a timer configured to count a predetermined fixed time, and
a timer management section configured to start a count when the answering BS instruction being notified of a first connection request, and instruct the management section to start the procedure to select the base station to send the connection answer based on the connectable number of a plurality of the base stations sent the connection requests when the predetermined fixed time being expired.

23. The server apparatus according to claim 20, further comprising:
a timer configured to count a predetermined fixed time, and
a timer management section configured to start a counts when the answering BS instruction section is notified of first connectable number, and instruct the management section to start the procedure to select the base station to return the connection answer among the base stations which notified the connection numbers when the predetermined fixed time expired.

24. A base station used for a mobile communication system establishing a communication connection between a mobile terminal sent a connection request and a base station sent a connection answer to the connection request, the mobile communication system having:
a mobile terminals configured to send a connection request;
a plurality of base stations;
a management section configured to manage each connectable number indicating a number of the mobile terminals with which each base station being possible to establish the communication connection, and to select the base station to send the connection answer to the mobile terminal that sent the connection request based on the connectable numbers managed; and
an answering BS instruction section configured to instruct the management section to start the procedure to select the base station, and to instruct the base station selected by the management section to send the connection answer when the mobile terminal sends the connection request; wherein the base station is configured to transfer the connection request when the base station receives the connection request from the mobile terminal.

25. The base station according to claim 24, wherein the base station sends radio resource to the answering BS selection section when a start of the communication between the base station and the mobile terminal and when an end of the communication between the base station and the mobile terminal.

26. The base station according to claim 24, wherein the base station sends the connection request to the answering BS selection section when the base station receives the connection request from the mobile terminal.

27. The base station according to claim 24, wherein the base station sends the connectable number to the answering BS selection section when the base station receives the connection request from the mobile terminal.

28. The base station according to claim 26 or 27, wherein the base station has a common channel band which the mobile terminal communicates with a plurality of the base stations by broadcasting and receives a connection request broadcasted by the mobile terminal using the common channel band.

29. The base station according to claim 24, wherein the base station includes the management section and the answering BS instruction section.

30. The base station according to claim 24, wherein the base station deletes the connection request received from the mobile terminal when the base station receives the notice of connection change from the answering BS instruction section.

31. A mobile terminal used for a mobile communication system, the mobile communication system having:
a mobile terminal configured to send a connection request;
a plurality of base stations, each base station being configured to send a connection answer to the connection request to the mobile terminal sent the connection request and to establish a communication connection with the mobile terminal sent the connection request;
a management section configured to manage each connectable number indicating a number of the mobile terminals with which each base station being possible to establish the communication connection, and to perform a procedure to select the base station to send the connection answer to the mobile terminal that sent the connection request based on the connectable numbers managed; and
an answering BS instruction section configured to instruct the management section to start the procedure to select the base station to send the connection answer, and to instruct the base station selected by the management section to send the connection answer; wherein the mobile terminal broadcasts the connection request to a plurality of the base station.

32. A mobile terminal used for a mobile communication system, the mobile communication system having:
a mobile terminal configured to send a connection request;
a plurality of base stations, each base station being configured to send a connection answer to the connection request to the mobile terminal sent the connection request and to establish a communication connection with the mobile terminal sent the connection request;
a management section configured to manage each connectable number indicating a number of the mobile terminals with which each base station being possible to establish the communication connection, and to perform a procedure to select the base station to send the connection answer to the mobile terminal that sent the connection request based on the connectable numbers managed; and
an answering BS instruction section configured to instruct the management section to start the procedure to select the base station to send the connection answer, and to instruct the base station selected by the management section to send the connection answer; wherein the mobile terminal sends the connection requests to a plurality of the base station in order.
